(19) United States
(12) Patent Application Publication
(10) Pub. No.: US 2025/0143204 A1
(43) Pub. Date: May 8, 2025

(54) Method for Aerating Manure Pits using Tubes with Emitters

(71) Applicant: Grimm's Gardens, L.L.C., Hiawatha, KS (US)

(72) Inventor: Kurt D. Grimm, Hiawatha, KS (US)

(73) Assignee: Grimm's Gardens, L.L.C., Hiawatha, KS (US)

(21) Appl. No.: 18/938,897

(22) Filed: Nov. 6, 2024

Related U.S. Application Data
(60) Provisional application No. 63/597,303, filed on Nov. 8, 2023.

(51) Int. Cl. A01C 3/02; B01F 23/231; B01F 101/00

(52) U.S. Cl. CPC A01C 3/026; B01F 23/2311; B01F 2101/005

(57) ABSTRACT

A method for aerating a manure pit by providing fluid at a pressure of greater than 10 psi within a plurality of tubes placed in designated zones of the manure pit. Tubes are mounted below a raised floor of the manure pit at an average depth of between 12″ and 120″ below a top surface of the manure. Fluid is emitted into the manure at a flow rate that is maintained between 0.1 GPH and 1.0 GPH through a series of emitters positioned along the length of each tube. Each emitter prevents backflow of manure into the tube and reduces the volume of fluid released into the pit relative to fluid pressure within the tube. The aeration process produces small bubbles having an approximate diameter of between 1 micrometer and 1 millimeter to promote the efficient decomposition of organic matter while reducing odors from the manure pit.

### CROSS REFERENCES

This application is a U.S. Non-Provisional Application which claims the benefit of U.S. Provisional Application No. 63/597,303, entitled “Manure Pit Digester System”, filed on 8 Nov. 2023, which is incorporated herein by reference in its entirety.

### REFERENCE TO RESEARCH

Not Applicable.

### REFERENCE TO CDS

Not Applicable.

### FIELD OF THE INVENTION

The present disclosure relates to a method and a manure management system that uses fluid-delivery tubes having emitters that provide continuous low flow gas to aerate manure slurry.

### BACKGROUND

Various compressed air systems and methods have been employed to keep manure in a homogeneous, pumpable state that is ready for extraction. Aeration systems also promote decomposition and reduce odors in manure pits. Mechanical agitators or pumps may be used to circulate the manure within the pit to facilitate the exchange of gases and promote aerobic conditions. Manure management systems can be energy-intensive, relatively expensive, and require high volumes of compressed air to be supplied for mixing and agitating manure as air passes to the surface.

### SUMMARY

In some aspects, the method includes the steps of: (a) disposing a plurality of tubes within zones of the manure pit; (b) emitting fluid through a plurality of emitters that are disposed along a longitudinal length of a tube; and (c) decreasing the volume of fluid, wherein an emitter decreases the volume of fluid emitted into the manure pit.

In some aspects, the emitter decreases the volume of fluid emitted relative to increased fluid pressure within the tube.

In some aspects, the fluid emitted is in the form of small bubbles having an approximate diameter of between 10 micrometers and 1 millimeter.

In some aspects, the fluid emitted is in the form of micro bubbles having an approximate diameter between 1 micrometer and 10 micrometers.

In some aspects, a separation distance along the tube between adjacent emitters is between 6 inches and 48 inches.

In some aspects, the method further includes the step of: (a) providing a gas to the plurality of tubes at a pressure of between 15 pounds per square inch to 60 pounds per square inch.

In some aspects, the method further includes the step of: (a) providing a gas within the tubes at a pressure of greater than 10 pounds per square inch.

In some aspects, the emitter emits the fluid at a flow rate that ranges between 0.1 gallons per hour and 1.0 gallons per hour.

In some aspects, the method further includes the step of: (a) mounting the plurality of tubes below a raised floor of the manure pit at an average depth of between 12 inches to 120 inches below a top surface of the manure.

In some aspects, the method further includes the step of: (a) laterally separating runs of tubing of the plurality of tubes at between 12 inches and 80 inches across a floor of the manure pit.

In some aspects, the emitter prevents manure from backflowing into the tube.

In some aspects, the emitter has an anti-siphon function that seals against back pressure from manure contained within the manure pit.

In some aspects, the emitter is structured as a one-way check valve that opens upon application of at least 2 pounds per square inch of fluid pressure delivered from the tube.

In some aspects, the method further includes the step of: (a) automatically transferring debris out of the plurality of tubes with a flushing mechanism.

In some aspects, the emitter has a pressure compensating range of between 14.5 to 58 pounds per square inch and delivers at a flow rate of between 0.02 and 0.04 cubic feet per minute.

In some aspects, a manure digestant is emitted through the emitter to catalyze the decomposition of manure.

In some aspects, the tube is a dripline used in subsurface water irrigation applications.

The above advantages and features are of representative embodiments only, and are presented only to assist in understanding the invention. It should be understood that they are not to be considered limitations on the invention as defined by the claims. Additional features and advantages of embodiments of the invention will become apparent in the following description, from the drawings, and from the claims.

### BRIEF DESCRIPTION OF DRAWINGS

Aspects are illustrated by way of example, and not by way of limitation, in the accompanying drawings, wherein:

FIG. 1 depicts an example of the manure pit aeration-digestor system installed in a barn.

FIG. 2 depicts a flow meter connected to the main pipe between the compressor and valve banks.

FIG. 3 depicts a header pipe fluidly mounted to the main pipe to provide uniform distribution of fluid flow to a valve bank.

FIG. 4 depicts a plurality of tubes of the manure pit aeration-digester system mounted to floor of a manure pit.

FIG. 5 depicts a mounting bracket structured to maintain a tube against the floor.

FIG. 6 depicts sensors positioned to monitor the air quality above the surface of manure within the underlying manure pit.

FIG. 7 depicts another view of the manure pit aeration-digestor system installed in the barn.

FIG. 8 depicts an example of a dripline structured with a one-piece construction design having an internally built drip emitter that is self-contained within the wall of the dripline.

FIG. 9 is a flowchart of an example method for aerating a manure pit to improve and maintain optimal conditions of the manure stored in the manure pit.

### DETAILED DESCRIPTION

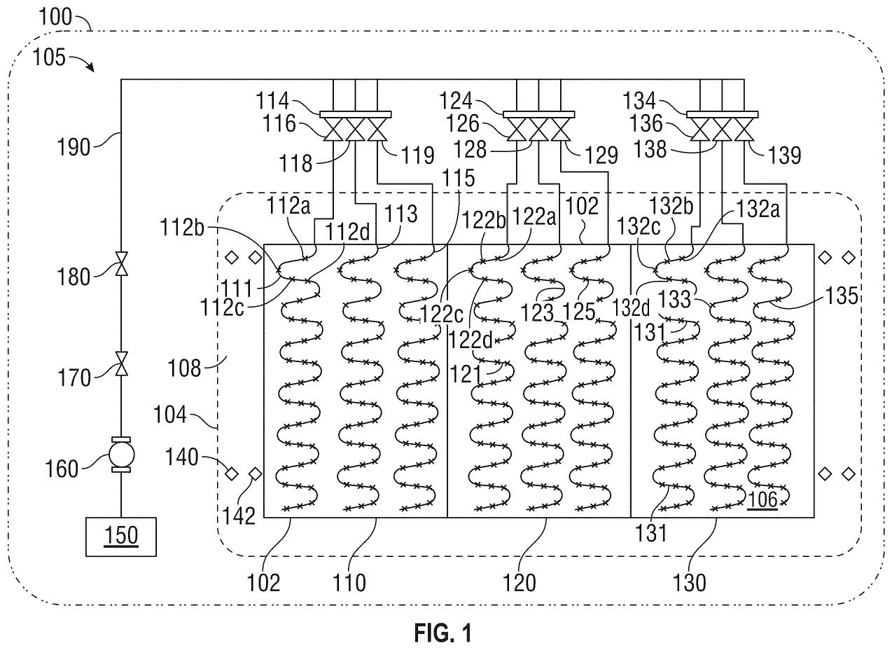

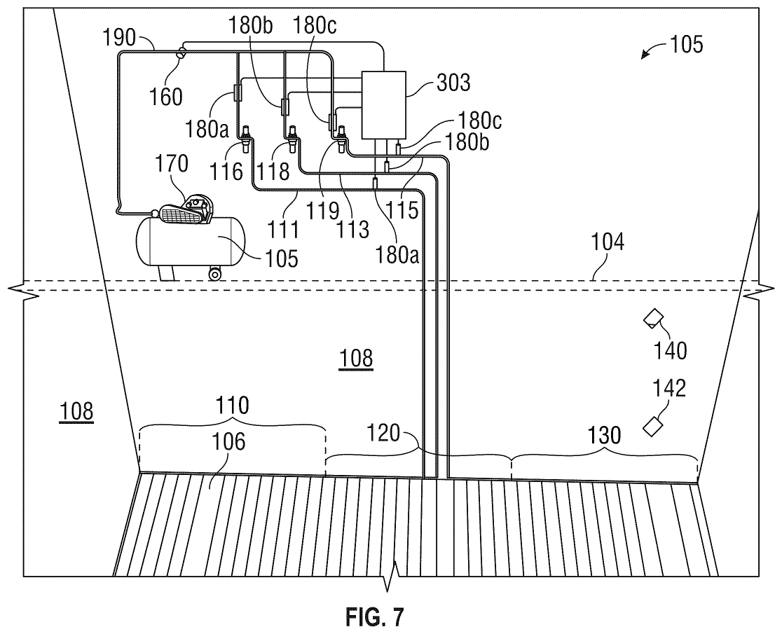

FIG. 1 depicts a manure pit aeration-digestor system-hereinafter referred to as “digester system 105”-installed in a barn 100 that houses livestock, such as dairy cattle, beef cattle, and hogs, especially for confinement operations. FIG. 7 is another view of the digester system 105 installed within walls 108 of the barn 100. Barn 100 may have a raised floor 104 that is slotted or made of slats. The raised floor 104 is disposed over a manure pit 102 that collects animal waste, including fecal matter. Digester system 105 may also be installed within outside farm manure pits, above or below ground lagoons and tanks, slurry stores, feedlots, or pens. Traditional aeration systems may be operated to provide a high volume of gas at a low pressure (i.e., less than 10 pounds per square inch (psi)) into manure. Digester system 105 may be operated to provide a low volume of gas into manure at a pressure that is higher than traditional systems (i.e., greater than 10 psi).

A plurality of tubes structured to emit gas during an operating cycle of the digester system are disposed in the manure pit 102. The plurality of tubes aerate and agitate manure 50 collected into the manure pit 102. The gas is emitted across the surface area of the manure pit 102 at regular intervals along a medial axis of each tube. Emitters being disposed, inline, along the medial axis of each tube provides for a greater distribution of gas emission, with small bubbles. Smaller bubbles impart increased contact with adjacent manure 50 over a greater surface area when emitted across manure pit 102. Uniform agitation also occurs as the numerous, small bubbles formed by the digester system 105 disperse through the manure 50. This agitating effect prevents manure 50 within the manure pit 102 from forming stagnant layers that are prone to housing parasites and becoming septic due to colonization of harmful microorganisms.

The plurality of tubes used in the digester system 105 may be the type traditionally used in surface or subsurface water irrigation applications, such as driplines, drip tape, rigid drip pipes, or drip hoses. The plurality of tubes have a plurality of emitters, each emitter 112a, 112b, 112c, 112d being disposed integrally within a wall 109 of the tube 111. The emitters may be inserted into the tubing at regular intervals after manufacture of tubing or be pre-inserted and made integral with tubing during manufacturing. Emitters 112a, 112b, 112c, 112d may be positioned in a medial axis of the tube, inline, along the longitudinal length of the tube 111. Digester system 105 may continuously mix the manure 50 through uninterrupted emission of fluid 155, such as gas or liquids, into the manure 50 along the longitudinal length of each tube 111, 113, 115, 117, 121, 123, 125, 131, 133, 135 of the plurality of tubes.

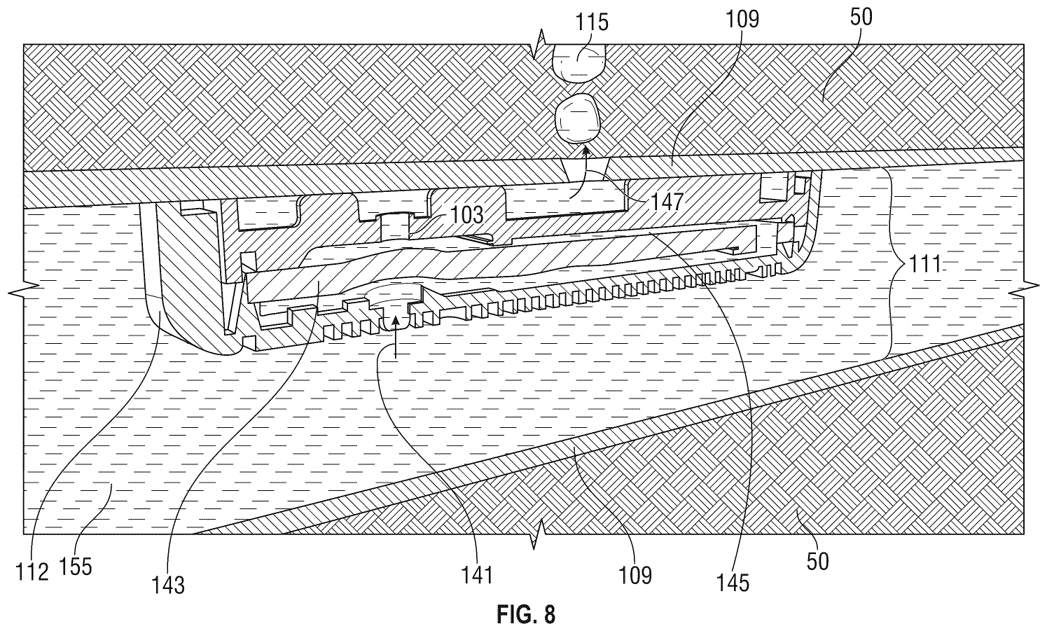

The plurality of tubes with emitters may be driplines with hard, structured walls that are rigid. The wall 109 thickness may be between 0.5 mm and 1.6 mm, or further between 0.7 mm and 1.4 mm, or between 0.9 mm and 1.2 mm. The driplines may be a one-piece construction design having an internally built drip emitter (shown in FIG. 8) that is self-contained within the wall 109. The emitters 112a, 112b, 112c, 112d, may be evenly spaced along tube 111 to apply an even amount of fluid 155 along the longitudinal length of tube 111. The pipes or tubes of the digester system 105 may be made from low- or high-density polyethylene or other materials such as galvanized steel, copper, plastic, polyvinyl chloride, chlorinated polyvinyl chloride, polyethylene, cross-linked polyethylene (PEX), or other suitable rigid material. Sizes and materials that are selected for the tubes may be dictated based on the flow rates and pressures within the digester system 105.

The diameter of tubing in each of the plurality of tubes may be between ¼ inches (″) and 2″. Tubing diameters may be further between ⅝″ and 1⅜″, between ½″ and 1″, or between ¼″ and ¾″ in diameter. The tubing may be made from hard-walled tubing that is extruded or welded in segments. Diameters may range from 16 millimeters (mm) (approximately 0.625″ or ⅝″) to 35 mm (approx. 1.375″ or 1⅜″). Diameters may range from 16 mm (approx. 0.625″ or ⅝″) to 22 mm (approx. 0.875″ or ⅞″) in manure applications. Thicknesses may range from 10 to 20 mils.

Different tube diameters, thicknesses, and sizes might be utilized depending on the application site. At one application site, the tubing utilized for the digester system 105 was sized with an 0.66″ outside diameter (OD), 0.56″ inside diameter (ID), with a 0.050″ thick wall. Specifically, the preferred tubing utilized was Netafim's Techline CV 17-millimeter (mm) dripline. This dripline includes a plurality of in-line drip emitters that are pre-inserted as a part of the dripline used in a drip irrigation system.

The emitter 112 may be rated to emit a fluid 155 at a flow rate that ranges between 0.1 gallons per hour (GPH) and 1.0 GPH. Flow rates for an emitter 112 may be further between 0.26 GPH and 0.9 GPH, between 0.4 GPH and 0.9 GPH, between 0.6 GPH and 0.9 GPH, between 0.26 GPH and 0.4 GPH, between 0.26 GPH and 0.6 GPH, between 0.4 GPH and 0.6 GPH, or between 0.4 GPH and 0.9 GPH in flow rate.

Emitters may have a barrier 103 for preventing manure 50 or other debris from backflowing into the tube. The barrier 103 may serve as a one-way check valve that opens upon application of at least 2 psi of fluid pressure delivered from the tube. A diaphragm 143, which may be made of silicone, may function as an anti-siphon feature to seal against back pressure from manure 50 contained within the manure pit 102. The seal formed may hold against between 5′ up to 10′ of manure depth from the floor 106 of the manure pit 102. Additionally, the one-way check valve prevents manure 50 intake into tubing that may be caused by a vacuum formed inside the tube. An automatic self-flushing mechanism 145, such as an offset emitter flow path or flush valve, may be incorporated to transfer detected debris out of digester system 105.

The separation distance between emitters may range between 6″ and 48″. Separation distances between emitters may be further between 6″ and 42″, between 6″ and 36″, between 6″ and 30″, between 6″ and 24″, between 6″ and 18″, between 6″ and 12″, between 12″ and 48″, between 12″ and 42″, between 12″ and 36″, between 12″ and 30″, between 12″ and 24″, between 12″ and 18″, between 18″ and 48″, between 18″ and 42″, between 18″ and 36″, between 18″ and 30″, between 18″ and 24″, between 24″ and 48″, between 24″ and 42″, between 24″ and 36″, or between 24″ and 30″ in separation distance between each emitter 112 of the plurality of emitters. Different emitters spacings might be utilized depending on the application parameters.

Coil lengths utilized for each lateral run of tubing for the plurality of tubes may be between 100 feet (′) and 1,500′. Tube coil lengths may be further between 100′ and 1,250′, between 100′ and 1,000′, between 100′ and 750′, between 100′ and 500′, between 100′ and 250′, between 250′ and 1,500′, between 250′ and 1,250′, between 250′ and 1,000′, between 250′ and 750′, between 250′ and 500′, between 500′ and 1,500′, between 500′ and 1,250′, between 500′ and 1,000′, or between 500′ and 750′ in length for each lateral run of a tube of the plurality of tubes.

At one application site, the coil length was approximately 1,000′ for each lateral run of tubing, though application of shorter or longer lateral runs are possible based on zone sizes. Each lateral run of tubing of the plurality of tubes laid within each zone 110, 120, 130 may be equal in length. Lateral runs having equal lengths provide balanced application of equal amounts of fluid 155 across each zone 110, 120, 130.

The bending radius (α) of the tubing into curves for each lateral run may be between 4″ and 10″. Bending radiuses may be further between 4″ and 8″, between 4″ and 6″, between 6″ and 10″, or between 6″ and 8″ of bending radius at a curve of the lateral run. At one application site, the tubing utilized had a bending radius (α) of 7″ when curved into sinusoidal patterns across the floor 106 of each zone 110, 120, 130 of the manure pit 102.

Lateral separation 201 between runs of tubing across the floor 106 of each zone 110, 120, 130 may be between 12″ and 80″. Lateral separation 201 between tubes may be further between 12″ and 18″, between 12″ and 24″, between 12″ and 30″, between 12″ and 36″, between 12″ and 42″, between 12″ and 48″, between 12″ and 54″, between 12″ and 60″, between 12″ and 66″, between 12″ and 72″, between 18″ and 24″, between 18″ and 30″, between 18″ and 36″, between 18″ and 42″, between 18″ and 48″, between 18″ and 54″, between 18″ and 60″, between 18″ and 66″, between 18″ and 72″, between 18″ and 80″, between 24″ and 30″, between 24″ and 36″, between 24″ and 42″, between 24″ and 48″, between 24″ and 54″, between 24″ and 60″, between 24″ and 66″, between 24″ and 72″, between 24″ and 80″, between 30″ and 36″, between 30″ and 42″, between 30″ and 48″, between 30″ and 54″, between 30″ and 60″, between 30″ and 66″, between 30″ and 72″, between 30″ and 80″, between 36″ and 42″, between 36″ and 48″, between 36″ and 54″, between 36″ and 60″, between 36″ and 66″, between 36″ and 72″, between 36″ and 80″, between 42″ and 48″, between 42″ and 54″, between 42″ and 60″, between 42″ and 66″, between 42″ and 72″, between 42″ and 80″, between 48″ and 54″, between 48″ and 60″, between 48″ and 66″, between 48″ and 72″, between 48″ and 80″, between 54″ and 60″, between 54″ and 66″, between 54″ and 72″, between 54″ and 80″, between 60″ and 66″, between 60″ and 72″, between 60″ and 80″, between 66″ and 72″, between 66″ and 80″, or between 72″ and 80″ for lateral separation 201 between tubes of the plurality of tubes. Different lateral separations between lateral runs of tubes may be selected based on the size of each zone 110, 120, 130 and the application parameters of the site. At one application site, the lateral separation 201 between tubes was approximately 60″.

A compressor 150 may be operably installed to a main pipe 190 within barn 100. The main pipe 190 may be approximately ½″ to four inches in diameter. The diameter of the main pipe 190 may be further between ½″ and 2″ line. A main pipe 190 with at least a 1″ diameter may be selected if there is more than 200′ of distance from the compressor to the valve banks.

Compressor 150 may operate at a relatively low power rating. Compressor 150 may supply a low volume of fluid to emit fluid 155 from the plurality of emitters at relatively low pressures. Even a small compressor having low horsepower may be operated with a low input of electrical, chemical, or mechanical energy to provide a sufficient volume of fluid during the manure aeration process. Nonetheless, safety features such as a manual exhaust valve or an air/vacuum relief vent may be included as part of the digester system 105.

Gas may be pressurized and serve several zones 110, 120, 130, simultaneously or independently. A screw compressor or standard piston style compressor may be utilized for the continuous supply of gas at low flow rates. For example, Powerex produces a model number SES050821, which is a 5-horsepower, 10-Gallon, Oil-Less Rotary Scroll Air Compressor which produces a cubic feet per minute (cfm) range of approximately 13-25 cfm and approximately 15.2 cfm at 100 psi. On the lower end of air pressure supplied to the digester system 105, results shown between 20 cfm and 30 cfm of air may pass through 1,000′ of tube when air is applied at between 10 psi to 25 psi. On the higher end of air pressure supplied to the digester system 105, between 10 cfm and 20 cfm of air may pass through 1,000′ of tube when air is applied at between 25 psi to 50 psi. A compressor 150 with the capability of providing a higher end of air pressure may not be necessary since the maximum recommended operating pressures for the tubes and emitters of the digester system 105 ranges between 15 psi to 60 psi.

Fluid 155, such as gas or liquids, supplied into main pipe 190 may be filtered before they are transferred through the compressor assembly. Alternatively, fluid may be filtered within the main pipe 190, such as within a flow meter 160 outfitted with a filter. Placing an air filter between the compressor 150 and valves prevents build-up on valves that may otherwise make them stick.

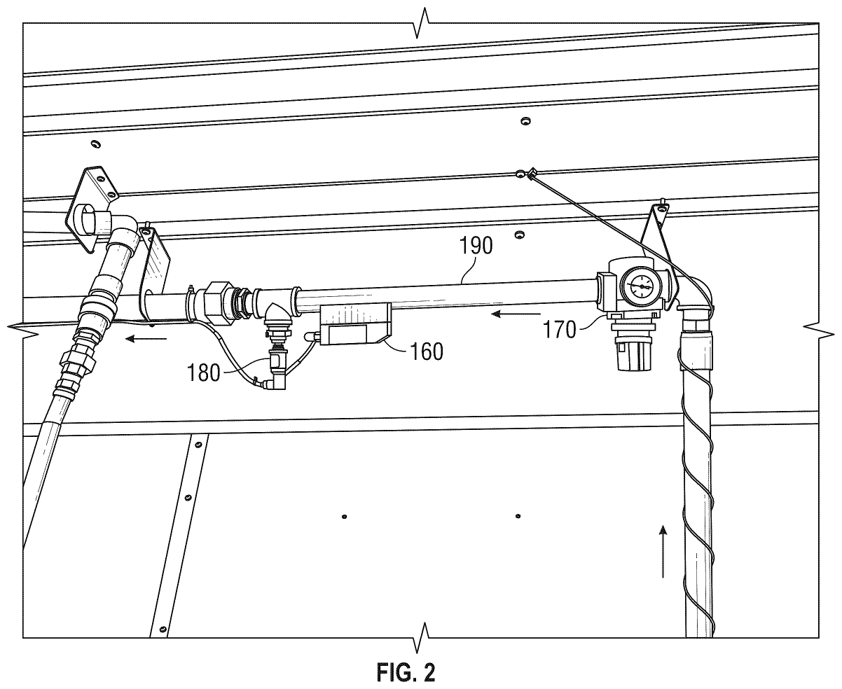

Now referring to FIG. 2, the flow meter 160 is shown disposed in the main pipe 190 between the compressor 150 and the valve banks. Flow meter 160 measures the bulk fluid movement (see movement arrows) through the main pipe 190. Flow meter 160 monitors the fluid flow rate, such as air flowing through the main pipe 190 from the compressor 150. Flow meter may be operably connected to the controller 303. Controller 303 may verify valves of the valve banks are opening based on the readings being obtained by the flow meter 160 in real-time. If the fluid flow rate is rising or falling past a preset threshold, alarms may sound or flash to alert an operator of the digester system 105.

A pressure regulator 170 may be disposed in main pipe 190 between the compressor 150 and the valve banks. Pressure regulator 170 may be a valve that controls the pressure of a fluid passing through main pipe 190 from compressor 150 to the valve banks. Pressure regulator 170 may be set to progressively open or close the main pipe 190 based upon feedback from the digester system 105 when the pressure rises or falls past a preset threshold. Alternatively, a pressure switch may be utilized in place of the pressure regulator 170. The pressure switch is an on/off device that works functionally like a light switch. A pressure switch may be set up to open or close main pipe 190 based upon the pressure in the digester system 105 rising or falling past the preset threshold.

A pressure transducer 180 may be disposed in the main pipe 190 between the compressor 150 and the valve banks. The pressure transducer 180 may be a sensor that gives continuous output signal of pressure on the digester system 105. The pressure transducer 180 may be electrically or wirelessly connected to controller 303, which monitors and performs actions based upon the output signal received by the pressure transducer 180. The pressure transducer 180 may be set to progressively alert controller 303 based upon the pressure in the digester system 105 rising or falling past a preset threshold. As shown in FIG. 7, a plurality of transducers 180a, 180b, 180c may be disposed between controller 303 and the plurality of tubes 111, 113, 115.

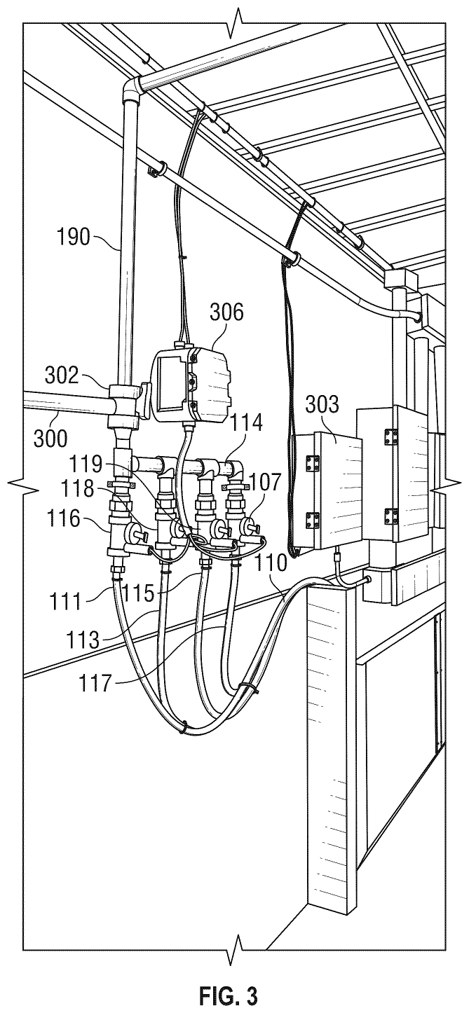

Now referring to FIG. 1 and FIG. 3, a header pipe 114, 124, 134 may be fluidly mounted to the main pipe 190 and provide a uniform distribution of fluid flow to each valve bank. Each of the headers may run to a respective valve bank and be fluidly connected thereto. The header pipe 114, 124, 134 fluidly connected to each valve bank may be between ½″ and 2″ in diameter. The valve bank may include a single valve or a plurality of valves to operate each zone 110, 120, 130 having a plurality of tubes. Each of the valves 116, 118, 119, 107, 126, 128, 129, 136, 138, 139 may be a lawn irrigation valve having between a ½″ and 1¾″ diameter connection. For a dripline having a diameter of ½″, a connection on the valve may have a ¾″ diameter. The valve 116, 118, 119, 107, 126, 128, 129, 136, 138, 139 may have a solenoid with a powered voltage of 24 VAC.

The valves may be operably connected back to a controller 303 through an automation control assembly 306. Controller 303 may be operated remotely through a wireless, or wired connection, such as through an internet connection. Valves may be operated by the controller 303 to control aeration cycles for each zone 110, 120, 130. The controller 303 may be a lawn irrigation controller utilized in subsurface drip irrigation systems.

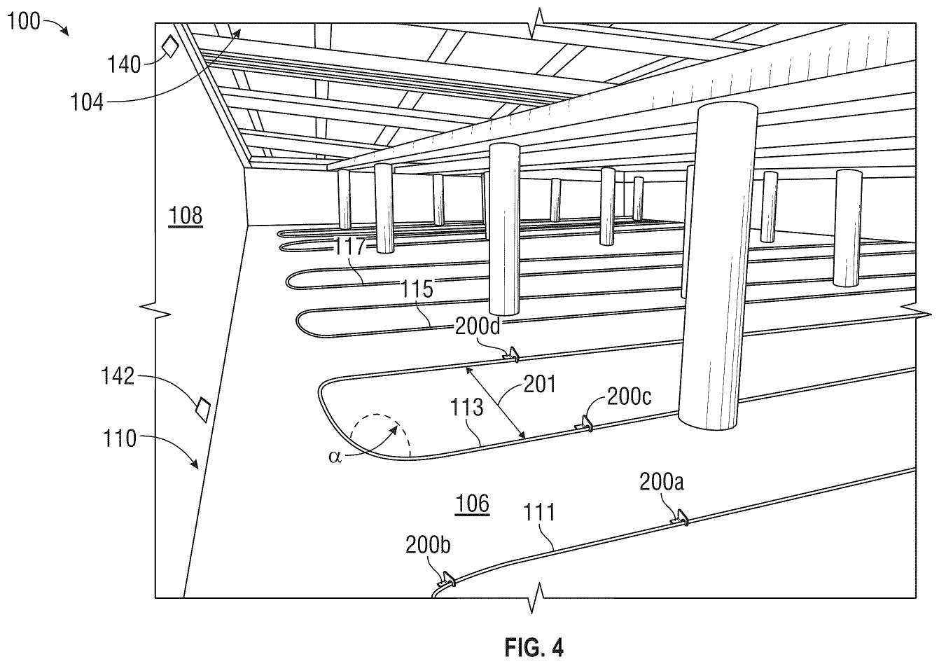

A plurality of tubes of digester system 105 may be mounted to floor 106 of the manure pit 102 as shown in FIG. 4. An anchor system 200 may be attached to the tubes or between the floor and the tubes. An example of the anchor system 200 may be a flexible cable that is joined with the tube to provide the buoyant tube with extra weight. Another example of the anchor system 200 may include a strip of material, such as a flat bar 210 that is made of metal. The flat bar 210 may be attached with adhesives, fasteners, or may simply rest against floor 106. Mounting brackets 200a, 200b, 200c, 200d for attaching the plurality of tubes to the floor 106 may, or may not, be disposed along a length of the flat bar 210.

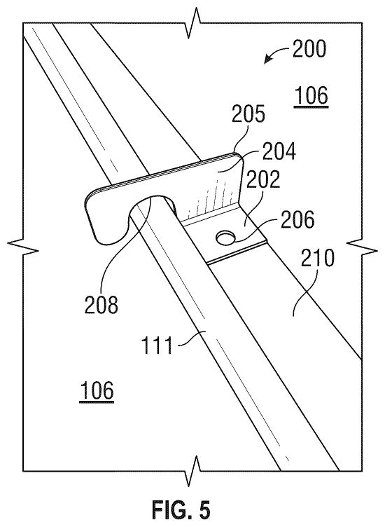

FIG. 5 depicts a mounting bracket 205 to maintain the tubes against the floor, as tubes may have buoyancy when filled with a fluid 155 that is less dense when compared to the adjacent manure 50. The mounting bracket 205 may have a first plate 202 with aperture 206 disposed therethrough for placement of a fastener. Stainless steel may be utilized for the mounting brackets 200a, 200b, 200c, 200d and fasteners to prevent corrosion. A second plate 204 of the mounting bracket 205 may have aperture 208 with an arched opening structured to receive a tube diameter. A cross-section of the mounting bracket 205 may be L-shaped. A plurality of mounting brackets of anchor system 200 may be attached directly to floor 106 or the flat bar 210.

Plurality of tubes may be mounted below a raised floor 104 of manure pit 102 at an average depth of between 12″ to 120″ below a top surface of manure 50. Distances between the top surface of manure 50 and a tube may be further between 12″ and 96″, between 12″ and 72″, between 12″ and 48″, between 12″ and 24″, between 24″ and 120″, between 24″ and 96″, between 24″ and 72″, between 24″ and 48″, between 48″ and 120″, between 48″ and 96″, or between 48″ and 72″ for an average depth of the plurality of tubes to the top surface of the manure 50 within manure pit 102.

During operation, emitters may emit a continuous flow (see movement arrows 141, 147 in FIG. 8) of fluid 155 without interruption of the continuous flow. Emitters may have a broad pressure compensating range of between 14.5 to 58 psi. Therefore, emitters may deliver and apply precise and equal amounts of gas along the tube over a broad pressure range.

Emitters may emit gas in the form of small bubbles or micro bubbles. Emitters may emit bubbles having an approximate diameter of between one micrometer (μm) and one millimeter (mm). Diameters of gas bubbles emitted by an emitter 112 may be further between 1 μm and 10 μm, between 1 μm and 100 μm, between 1 μm and 1 mm, between 10 μm and 100 μm, between 10 μm and 1 mm, or further between 100 μm and 1 mm. In other applications, emitters may be structured to emit gas in the form of large bubbles. Emitters may emit large bubbles having an approximate diameter of between 1 mm and 10 mm.

Table 1 presents air calculations for emitters (approx. 667 emitters per 1000′ of tube coil length) rated at 0.26 GPH, which are typically used in water irrigation applications.

TABLE 1

| Air pressure | 1000′ feet of | Single emitter |
|---|---|---|
| (psi) | tubing (cfm) | flow rate (cfm) |
| 14 | 24.69 | 0.04 |
| 15 | 24.69 | 0.04 |
| 25 | 17.73 | 0.03 |
| 28 | 18.67 | 0.03 |
| 30 | 17.44 | 0.03 |
| 34 | 16.86 | 0.03 |
| 38 | 16.59 | 0.03 |
| 44 | 11.43 | 0.02 |

Table 2 presents data from an operating cycle for a manure aeration process.

TABLE 2

| Zone # | Run time | Target Pressure |
|---|---|---|
| 1 | 60 secs | 30 psi |
| 2 | 60 secs | 30 psi |
| 3 | 60 secs | 30 psi |
| 4 | 60 secs | 30 psi |
| 5 | 60 secs | 30 psi |
| 6 | 60 secs | 30 psi |
| 7 | 60 secs | 30 psi |
| 8 | 60 secs | 30 psi |
| 9 | 60 secs | 30 psi |
| 10 | 60 secs | 30 psi |
| 11 | 60 secs | 30 psi |
| 12 | 60 secs | 30 psi |
| 13 | 60 secs | 30 psi |
| 14 | 60 secs | 30 psi |
| 15 | 60 secs | 30 psi |
| 16 | 60 secs | 30 psi |
| 17 | 60 secs | 30 psi |

* each zone cycled 8 times per day every 3 hours.

Zones may be operated at the same time. Alternatively, zones may be turned on and off, chronologically, at regular intervals during the operating cycle.

Sensors 40, 42, 140, 142 operably connected to controller 303 may monitor, obtain, and send data continuously in real-time. Sensors 40, 42, 140, 142 may detect amounts of gases escaping into the livestock barn 100. Sensors may be disposed above, or below, the raised floor 104, to detect nuisance gases before being transmitted outside the livestock barn 100 via exhaust fans. Uniform aeration and agitation across the floor 106 of the manure pit 102 by the digester system 105 reduces odors and amounts of nuisance gases, such as methane (CH4) ammonia (NH3) and hydrogen sulfide (H2S). In one application, the NH3 and H2S were reduced, on average, to less than 15 ppm and 3 ppm, respectively.

Table 3 presents a comparison of monitoring results of NH3 in the barn 100 for manure 50 being treated with aeration by the digester system 105 and without aeration.

Table 4 presents a comparison of monitoring results of H2S in the barn 100 for manure 50 being treated with aeration by the digester system 105 and without aeration.

The gas emitted may be a gas that facilitates aerobic or anaerobic conditions within the manure 50 collected within the manure pit 102. The selected gas may be emitted through the plurality of emitters from a pressurized source to the manure 50 surrounding the plurality of emitters. Inside the manure pit 102, the manure 50 undergoes aerobic or anaerobic digestive fermentation to form a liquid, semi-solid, or solid fertilizer. In the present application, digester system 105 is operated to form a final manure product that is substantively a liquid fertilizer.

Without the digester system 105, manure 50 within a traditional manure pit may have a solids content that ranges from between 8% and 12%, or over 12% solids content. With operation of the digester system 105, the solids content of the final manure product is below 8% solids content. With use of the digester system 105, the solids content of the final manure product may range from between 1% to 8% solids content. The solids content may be further between 2% to 6%, between 3% and 5%, or between 4% and 6% solids content in the final manure product. At one application site, the final manure product had a solids content of less than 5% solids content.

The digester system 105 may function to form a wide range of aerobic and anaerobic conditions within the manure 50 collected within the manure pit 102. An operator may adjust inputs into the digester system 105 to modify manure parameters, such as temperature and percent of oxygen saturation. For example, an input into the digester system 105 may be conditioned air that is heated or cooled to increase or decrease, respectively, the temperature of the manure 50. In another example, air with a percent oxygen saturation that is lower than the ambient atmospheric environment may be pumped into the digester system 105 to maintain an anaerobic environment. Alternatively, air with a percent oxygen saturation that is higher than the ambient atmospheric environment may be pumped into the digester system 105 to maintain an aerobic environment so that, for example, biologicals added to the manure 50 may function under viable conditions.

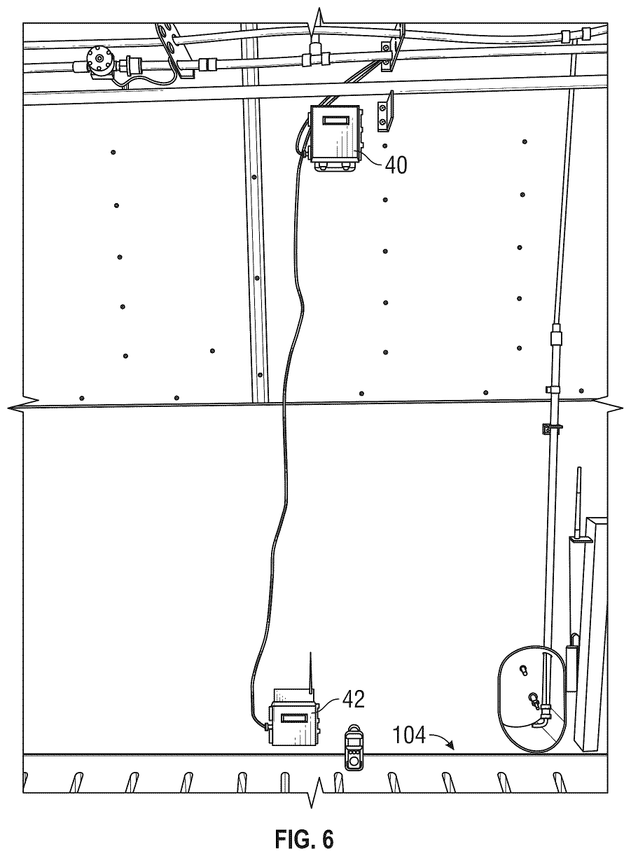

The digester system 105 may also adjust the volume of ambient air delivered into the manure pit 102 to maintain, or cycle through, aerobic or anaerobic environments within the manure 50 based on the decomposition conditions selected. As shown in FIG. 6, sensors 40, 42 monitoring the air quality above the surface of the manure 50 may provide data that correlates to the manure's decomposition condition as monitored by sensors 140, 142 below the surface of manure 50 (shown in FIG. 4), whether undergoing aerobic or anaerobic conditions. Based on the continuous readings, aeration by the digester system 105 may be increased or decreased. Results of utilizing the digester system 105 include reduced solids, elimination of or reduced pit crusting of manure 50 on the surface of the pit floor 106 and walls 108, reduced noxious odors and dangerous gases, and increased nutrient value in the final manure product for crop production.

Referring back to FIG. 3, a fluid 155 containing a manure digestant may pass through the digester system 105 through an additive pipe 300 connected to the main pipe 190 of the digester system 105. The additive line may be fluidly connected by way of a T-valve 302 disposed between the compressor 150 and valve banks. The manure digestant may pass through the plurality of emitters 112a, 112b, 112c, 112d, 122a, 122b, 122c, 122d, 132a, 132b, 132c, 132d to manure 50 surrounding the plurality of tubes to catalyze decomposition of the manure 50. Decomposition of the manure 50 reduces the solids content of the manure 50 produced from dairy cattle, beef cattle, swine, and other livestock.

The manure digestant may contain a broad spectrum of enzymes, including fibrolytic enzymes that break down fiber, deflocculants, microorganisms, biological inoculants, heterotrophic bacteria, fungi, or other living microbes that aid in the digestion and fermentation of the solid manure by the digester system 105 for formation of solid manure into liquid manure. Digester system 105 delivers the selected digester to the manure pit 102 through the plurality of tubes.

For example, digester system 105 may maintain an aerobic environment by emitting an oxygen gas into the manure 50 to aid in digestion of manure 50. Manure 50 may be incorporated with a manure digestant when delivered by digester system 105. Digester system 105 may deliver the manure digestant within a liquid form that is transferred from source containers, such as 5-gallon buckets up to 300-gallon totes, through the additive pipe 300 connected to the main pipe 190. The manure digestant may be utilized when livestock producers feed livestock with higher inclusion of distiller's dried grains with solubles (DDGS). Therefore, the manure digestant may be a multi-enzyme blend with fibrolytic enzymes for breakdown of manure solids having a high content of undigested substances (i.e., fibers, starches, or other organic matter).

In another example, the manure digestant may include viable microorganisms that produce the enzymes that increase decomposition of the solid content of the manure 50 and associated obnoxious odors (i.e., ammonia, methane, hydrogen sulfide). The living microbes aid in liquefying the solids and organic content within the manure 50 to a final manure product that may be utilized as a liquid fertilizer for plants and crops.

Table 5 presents final manure nutrient results from manure treated by the digester system.

TABLE 5

| | As Received | lbs./1000 gallons | lbs./ton |
|---|---|---|---|
| Moisture | 96.88% | 968.8 | |
| Dry Matter | 3.12% | 31.2 | |
| Nitrogen (TKN) | 0.37% | 30.45 | 7.31 |
| Ammonium (N) | 0.27% | 22.20 | 5.33 |
| Organic Nitrogen | 0.10% | 8.25 | 1.98 |
| Phosphorus pentoxide (P₂O₅) | 0.09% | 7.39 | 1.77 |
| Potassium fertilizer (K20) | 0.27% | 22.80 | 5.47 |
| Calcium (Ca) | 0.04% | 3.72 | 0.89 |
| Magnesium (Mg) | 0.04% | 3.53 | 0.85 |
| Sodium | 0.07% | 5.72 | 1.37 |
| Sulfur (S) | 0.03% | 2.63 | 0.63 |
| Copper | 24.30 ppm | 0.20 | 0.05 |
| Iron | 18.70 ppm | 0.16 | 0.04 |
| Manganese | 6.87 ppm | 0.06 | 0.01 |
| Zinc | 30.19 | 0.25 | 0.06 |

Table 6 presents estimated available nutrients within the manure 50 after the 1st year of treatment by the digester system 105.

TABLE 6

| | Injected or Incorporated | | Surface Applied | |
|---|---|---|---|---|
| | as Liquid | as Solid | as Liquid | as Solid |
| | (lbs./1000 gal) | (lbs./1000 gal) | (lbs./1000 gal) | (lbs./ton) |
| Nitrogen | 23 | 5 | 11 | 3 |
| (TKN) | | | | |
| % P205 | 6 | 1 | 6 | 1 |
| % K20 | 21 | 5 | 21 | 5 |

Table 7 presents estimated values of an equivalent commercial fertilizer based on Table 6.

TABLE 7

| | Injected or Incorporated | | Surface Applied | |
|---|---|---|---|---|
| | as Liquid | as Solid | as Liquid | |
| | (lbs./1000 | (lbs./1000 | (lbs./1000 | as Solid |
| | gal) | gal) | gal) | (lbs./ton) |
| Nitrogen | $14.85 | $3.56 | $6.93 | $1.66 |
| (TKN) | | | | |
| % P205 | $4.43 | $1.06 | $4.43 | $1.06 |
| % K20 | $10.26 | $2.46 | $10.26 | $2.46 |
| Total $ Value | $29.54 | $7.08 | $21.62 | $5.18 |

Digester system 105 provides the ability to maintain the manure 50 as a suspended and liquified manure product throughout the duration of the manure collection period. Therefore, the liquified manure may be removed by pumping from the manure pit 102, without mechanical agitation, anytime of the year. Traditionally, collected manure 50 settles into distinct layers that must be mechanically agitated in order to be transported out of the manure pit 102 once, or several times, a year.

Additionally, incorporating a manure digestant may further liquefy the manure 50. The liquified manure may be applied to plants for quick absorption of nitrogen and phosphorus nutrients. Higher nitrogen values are retained within the liquified manure product due to treatment with the digester system 105 as may be correlated based on the lowered ammonia level shown in Table 3.

One of the main benefits of installing the digester system 105 into a livestock barn 100 is that a livestock operator may use the final manure product as a fertilizer. Digester system 105 aids this process by preventing stagnation and accumulated solids in the bottom of the manure pit 102. The digester system 105 aerates and agitates the manure 50 to reduce the solids content of the manure 50. As a result, a homogenized and liquified manure product can be produced and used as a highly concentrated and valuable fertilizer.

Digester system 105 forms the manure 50 into a liquid suspension that has a more uniform consistency which aids in decreased sludge density and increased transport characteristics. Higher nutrient contents of the liquified manure product allows producers to apply less manure product per acre. Digester system 105 provides a competitive advantage due to significant cost savings based on the low-cost parts and equipment utilized in the digester system 105.

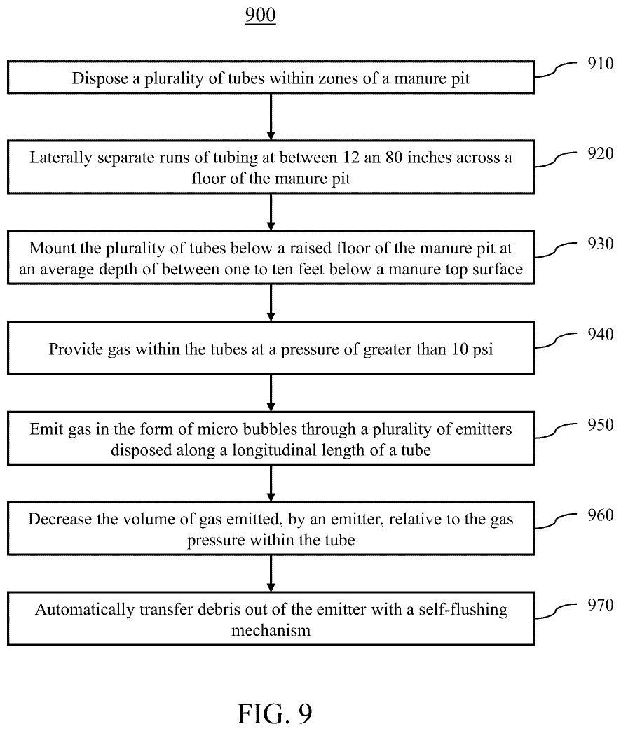

FIG. 9 is a flowchart of an example method 900 for aerating a manure pit to improve and maintain optimal conditions within manure pits. A plurality of tubes are disposed within zones of the manure pit, according to step 910. Runs of tubing are laterally separated at between 12 inches and 80 inches across a floor of the manure pit, according to step 920. The plurality of tubes are mounted below a raised floor of the manure pit at an average depth of between 12 inches to 120 inches below a top surface of the manure, according to step 930. Gas is provided within the tubes at a pressure of greater than 10 pounds per square inch, according to step 940. Gas is emitted in the form of micro bubbles through a plurality of emitters that are disposed inline along a longitudinal length of a tube, according to step 950. The volume of fluid emitted into the manure pit is decreased, by an emitter, relative to the gas pressure within the tube, according to step 960. Debris are automatically transferred out of the emitter with a self-flushing mechanism, according to step 970.

The manure pit aeration-digestor system and associated aerating method release air or other gases into the manure pit to create small bubbles, such as micro bubbles, that have greater surface area contact with manure while rising to facilitate greater gas exchange and aerobic decomposition. Uniform and consistent aeration of manure pits with air or other gases provided at low volumes provides a comprehensive and cost-effective solution. This system and associated method offer precise control over the low volume of fluid emitted and distributes the fluid throughout the entire manure pit enclosure, over a greater surface area of contact with manure, which prevents uneven decomposition rates and inconsistent odor control that may result from using existing manure management systems that aerate with high volumes of fluid emitted intermittently from localized points defined at terminal tube ends.

It is understood that the invention is not confined to the particular construction and arrangement of parts herein described. That although the drawings and specification set forth a preferred embodiment, and although specific terms are employed, they are used in a description sense only and embody all such forms as come within the scope of the following claims.

The present disclosure is not to be limited in terms of the particular embodiments described in this application, which are intended as illustrations of various aspects. Many modifications and variations can be made without departing from its spirit and scope. Functionally equivalent methods and apparatuses within the scope of the disclosure, in addition to those enumerated herein, are possible from the foregoing descriptions. Such modifications and variations are intended to fall within the scope of the appended claims.

For the convenience of the reader, the above description has focused on a representative sample of all possible embodiments, a sample that teaches the principles of the invention and conveys the best mode contemplated for carrying it out. Throughout this application and its associated file history, when the term “invention” is used, it refers to the entire collection of ideas and principles described; in contrast, the formal definition of the exclusive protected property right is set forth in the claims, which exclusively control. The description has not attempted to exhaustively enumerate all possible variations. Other undescribed variations or modifications may be possible. Where multiple alternative embodiments are described, in many cases it will be possible to combine elements of different embodiments, or to combine elements of the embodiments described here with other modifications or variations that are not expressly described. A list of items does not imply that any or all of the items are mutually exclusive, nor that any or all of the items are comprehensive of any category, unless expressly specified otherwise. In many cases, one feature or group of features may be used separately from the entire apparatus or methods described. Many of those undescribed variations, modifications and variations are within the literal scope of the following claims, and others are equivalent.

I claim:

1. A method of aerating a manure pit comprising the steps of:
a. disposing a plurality of tubes within zones of the manure pit;
b. emitting fluid through a plurality of emitters that are disposed inline along a longitudinal length of a tube; and
c. decreasing the volume of fluid, wherein an emitter decreases the volume of fluid emitted into the manure pit.

2. The method of claim 1, wherein the emitter decreases the volume of fluid emitted relative to increased fluid pressure within the tube.

3. The method of claim 1, wherein the fluid emitted is in the form of small bubbles having an approximate diameter of between 10 micrometers and 1 millimeter.

4. The method of claim 1, wherein the fluid emitted is in the form of micro bubbles having an approximate diameter of between 1 micrometer and 10 micrometers.

5. The method of claim 1, wherein a separation distance along the tube between adjacent emitters is between 6 inches and 48 inches.

6. The method of claim 1, further comprising the step of:
a. providing a gas to the plurality of tubes at a pressure of between 15 pounds per square inch to 60 pounds per square inch.

7. The method of claim 1, further comprising the step of:
a. providing a gas within the tubes at a pressure of greater than 10 pounds per square inch.

8. The method of claim 1, wherein the emitter emits the fluid at a flow rate that ranges between 0.1 gallons per hour and 1.0 gallons per hour.

9. The method of claim 1, further comprising the step of:
a. mounting the plurality of tubes below a raised floor of the manure pit at an average depth of between 12 inches to 120 inches below a top surface of manure.

10. The method of claim 1, further comprising the step of:
a. laterally separating runs of tubing of the plurality of tubes at between 12 inches and 80 inches across a floor of the manure pit.

11. The method of claim 1, wherein the emitter prevents manure from backflowing into the tube.

12. The method of claim 1, wherein the emitter has an anti-siphon function that seals against back pressure from manure contained within the manure pit.

13. The method of claim 1, wherein the emitter is structured as a one-way check valve that opens upon application of at least 2 pounds per square inch of fluid pressure delivered from the tube.

14. The method of claim 1, further comprising the step of:
a. automatically transferring debris out of the plurality of emitters with a self-flushing mechanism.

15. The method of claim 1, wherein the emitter has a pressure compensating range of between 14.5 to 58 psi.

16. The method of claim 1, wherein the emitter delivers at an air flow rate of between 0.02 cubic feet per minute and 0.04 cubic feet per minute.

17. The method of claim 1, wherein the fluid emitted is a manure digestant that catalyzes the decomposition of manure contained within the manure pit.

18. The method of claim 1, wherein the tube is a dripline used in drip irrigation watering applications.

19. The method of claim 1, wherein the emitter is disposed within the tube.
